(19) United States
(12) Patent Application Publication
(10) Pub. No.: US 2026/0329786 A1
(43) Pub. Date: Oct. 22, 2026

(54) TUNABLE BANDWIDTH EXTENSION OF INPUT/OUTPUT (I/O)

(71) Applicant: Micron Technology, Inc., Boise, ID (US)

(72) Inventors: Ming-ta Hsieh, Woodbury, MN (US); Nathan D. Henningson, Minneapolis, MN (US)

(21) Appl. No.: 19/560,404

(22) Filed: Mar. 9, 2026

Related U.S. Application Data
(60) Provisional application No. 63/772,065, filed on Mar. 14, 2025.

(51) Int. Cl. G06F 13/20; H02H 9/04

(52) U.S. Cl. CPC G06F 13/20; H02H 9/045

(57) ABSTRACT

Systems, methods and apparatus are provided for operating tunable bandwidth extension of I/O components. An example apparatus can include an I/O pad, a first signal driver coupled to the I/O pad with an intermediate node located between the first signal driver and the I/O pad, a second signal driver coupled to the I/O pad with the intermediate node located between the second signal driver and the I/O pad. The apparatus further includes a tunable capacitance component coupled to the intermediate node. The tunable capacitance component includes a set of capacitors that can be selectively enabled or disabled to adjust capacitive loading of the apparatus.

### PRIORITY INFORMATION

This application claims the benefit of U.S. Provisional Application Number 63/772,065, filed on Mar. 14, 2025, the contents of which are incorporated herein by reference.

### TECHNICAL FIELD

The present disclosure relates generally to electronic apparatuses and methods, and more particularly, to apparatuses and methods for operating tunable bandwidth extension of input/output (I/O).

### BACKGROUND

Electronic apparatuses (e.g., devices and systems) include various integrated circuits (ICs) (e.g., chips) such as microprocessors, controllers, memory devices, field programmable gate arrays (FPGAs), application specific integrated circuits (ASICs), and system-on-a-chip (SoC) integrated circuits, among various other types of digital and/or analog integrated circuits. Various ICs include input/output (I/O) circuitry that can provide an interface between ICs (e.g., to send and/or receive signals). Accordingly, I/O circuitry often includes a physical pin through which signals (e.g., data) can be communicated (e.g., transmitted and/or received). As such, in some instances, the term “I/O pin” can be used to refer to the physical pin as well as additional I/O circuitry (e.g., transmit driver circuitry, receiver driver circuitry, etc.) coupled thereto. I/O circuits configured to both transmit and receive signals are referred to as bidirectional I/Os, and I/O circuits configured to only transmit signals or only receive signals are referred to as unidirectional I/Os.

### BRIEF DESCRIPTION OF THE DRAWINGS

FIG. 1 is a block diagram of an apparatus in the form of a portion of an electronic system including input/output (I/O) components respectively including coil with tunable capacitance components in accordance with a number of embodiments of the present disclosure.

FIG. 2 is a block diagram illustrating an example I/O component including a coil with tunable capacitance component in accordance with a number of embodiments of the present disclosure.

FIG. 3 is a block diagram illustrating another example I/O component including a variant coil with tunable capacitance component in accordance with a number of embodiments of the present disclosure.

FIG. 4 is a flow diagram of a method for operating a coil with tunable capacitance component in accordance with a number of embodiments of the present disclosure.

### DETAILED DESCRIPTION

The growing demand for high-speed data communication in memory and processor systems has highlighted significant challenges in bi-directional Input/Output (IO) designs. Unlike unidirectional IOs, bi-directional IOs must accommodate both transmit (Tx) and receive (Rx) functionalities simultaneously, which introduces inherent limitations in bandwidth and speed. The root cause of these limitations lies in capacitive loading, which arises from shared routing, termination components, electrostatic discharge (ESD) protection circuits, and channel characteristics.

Termination, while essential for mitigating unwanted channel effects, adds to the capacitive load, and ESD circuits, required for protecting IO pads from external electrical surges, further compound this problem. To achieve acceptable performance in such systems, conventional approaches rely heavily on equalizers such as Feed-Forward Equalization (FFE) for Tx and Continuous-Time Linear Equalization (CTLE) and/or Decision Feedback Equalization (DFE) for Rx. However, these solutions result in increased power consumption, heightened design complexity, and limited scalability.

Existing designs that incorporate inductors, such as T-Coils, attempt to mitigate capacitive loading by leveraging inductive admittance to extend bandwidth. However, such implementations are limited to fixed bandwidth extension optimized for specific channel lengths or memory loads. When channel conditions deviate from these fixed parameters, the system experiences degraded performance, including unwanted signal peaking or attenuation, increased jitter, and reduced data rates. Moreover, T-Coils do not provide independent tuning for Tx and Rx paths, further restricting their applicability in high-performance systems.

Embodiments of the present disclosure addresses these shortcomings by introducing a novel bi-directional IO architecture that incorporates a tunable capacitor in conjunction with an innovative Y-Coil design. Unlike conventional T-Coils, the Y-Coil enables independent bandwidth tuning for Tx and Rx paths, accommodating varying channel lengths and memory configurations. By integrating a tunable capacitor, the invention provides dynamic adjustability to match system requirements, reducing dependence on high-power equalizers and simplifying circuit design.

This approach not only alleviates the adverse effects of capacitive loading but also enhances system performance by minimizing jitter and maximizing data rates. Embodiments of the present disclosure significantly reduces power consumption and design complexity, providing a scalable and efficient solution for next-generation high-speed communication systems.

As used herein, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected. Further, as used herein, the term “decrease”, “reduce”, and/or “lower” (or the like) can be interchangeably used to indicate the same meaning.

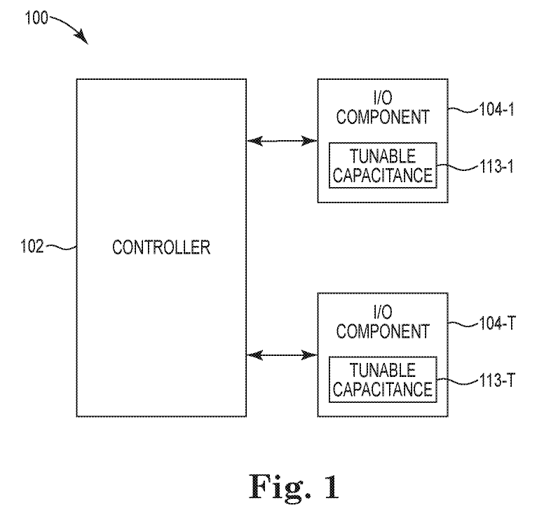

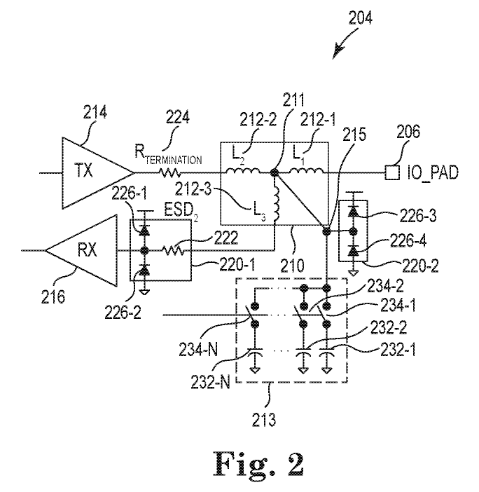

The figures herein follow a numbering convention in which the first digit or digits correspond to the drawing figure number and the remaining digits identify an element or component in the drawing. Similar elements or components between different figures may be identified by the use of similar digits. For example, 104 may reference element “04” in FIG. 1, and a similar element may be referenced as 204 in FIG. 2.

Analogous elements within a Figure may be referenced with a hyphen and extra numeral or letter. See, for example, elements 104-1, …, 104-T in FIG. 1. Such analogous elements may be generally referenced without the hyphen and extra numeral or letter. For example, elements 104-1, …, 104-T can be collectively referenced as 104. As used herein, the designators “T”, particularly with respect to reference numerals in the drawings, indicates that a number of the particular feature so designated can be included. As will be appreciated, elements shown in the various embodiments herein can be added, exchanged, and/or eliminated so as to provide a number of additional embodiments of the present disclosure. In addition, as will be appreciated, the proportion and the relative scale of the elements provided in the figures are intended to illustrate certain embodiments of the present invention and should not be taken in a limiting sense.

FIG. 1 is a block diagram of an apparatus in the form of a portion of an electronic system 100 including input/output (I/O) components 104-1, …, 104-T (collectively referred to as “I/Os 104”) respectively including tunable capacitance components 113-1, …, 113-T (collectively referred to as “tunable capacitance components 113”) in accordance with a number of embodiments of the present disclosure. As used herein, a controller 102 and I/Os 104 might also be separately considered an “apparatus.”

The I/Os 104 can include various circuitry to facilitate transmission of signals between electrical components (e.g., chips). For example, I/Os 104 can include one or more signal paths include conductive signal lines, transceivers (e.g., transmitter, receiver, etc.), I/O pads, etc. that can receive an external signal (e.g., signal received from an external device, such as controller 102) and/or output the received signal (e.g., to the controller 102). Although embodiments are not so limited, I/O 104 can be a bidirectional I/O that can transmit/receive signals from/to an I/O pad.

Although embodiments are not so limited, I/Os 104 can form various buses (e.g., data buses, address buses, command buses, etc.) and can be placed in various locations of the computing system. For example, I/O components can be placed among peripheral devices (e.g., sensors, actuators, displays, etc.), a host (e.g., a desktop computer, laptop computer, network server, mobile device, or such computing device that includes a memory and a processing device), storage system (e.g., including memory dice) etc. of the computing system.

In some embodiments, one or more of I/Os 104 can be part of (e.g., form) a “port”, which may be a physical port, such as serial advanced technology attachment (SATA) ports, peripheral component interconnect express (PCIe) ports, universal serial bus (USB) ports, Fibre Channel ports, Small Computer System Interface (SCSI) ports, Serial Attached SCSI (SAS) ports, a dual in-line memory module (DIMM) ports, an NVM Express (NVMe) ports, Open NAND Flash Interface (ONFI) ports, etc. Further, in some embodiments, I/Os 104 can be (e.g., integrated) part of the controller 102 instead of being separate components independently of the controller 102.

Controller 102 (alternatively referred to as “control circuit”) can include various circuitry to facilitate controlling various parts of the I/Os 104. For example, the controller 102 can include special purpose circuitry in the form of an ASIC, FPGA, state machine, and/or other logic circuitry or software and/or firmware that can allow the controller 102 to control parts of the I/Os 104, such as electromechanical switches.

In some embodiments, the controller 102 can be a device (e.g., testing equipment) that can control parts of the I/Os 104 during manufacturing and testing phases. In some embodiments, the controller 102 can be a device (e.g., of a computing device) that can control parts of the I/Os 104 during operation of the computing device. More particularly, the controller 102 are communicatively coupled to tunable capacitance components 113 of the I/Os 104 to selectively and/or dynamically enable and/or disable capacitors of each tunable capacitance component 113. In some embodiments, the controller 102 (alternatively referred to as “control circuit” 102) can be an integrated part of each I/O 104. For example, the I/O 104-1 can include a first control circuit 102 (to selectively and/or dynamically enable and/or disable capacitors of the I/O 104-1), while the I/O 104-T includes a second control circuit (to selectively and/or dynamically enable and/or disable capacitors of the I/O 104-T).

FIG. 2 is a block diagram illustrating an example I/O component 204 (alternatively referred to as “I/O 204”) including a tunable capacitance component 213 in accordance with a number of embodiments of the present disclosure. I/O component 204 can include a first signal driver of a transceiver (e.g., a transmitter 214 shown as “TX” in FIG. 2), a second signal driver of the transceiver (e.g., a receiver 216 shown as “RX” in FIG. 2). As used herein, the term “transceiver” generally refers to an input signal driver (e.g., a receiver) or an output signal driver (e.g., a transmitter) of an I/O component. Further, as used herein, the term “transmitter” can be alternatively referred to as “transmit driver”, “output signal driver”, etc. Further, the term “receiver” can be alternatively referred to as “receiver driver”, “input signal driver”, etc. As illustrated in FIG. 2, the transmitter 214 as an output signal driver is operable to drive a signal (e.g., received externally) to an I/O pad (e.g., I/O pad 206) and while the receiver 216 as an input signal driver is operable to drive a signal received from the I/O pad, such as I/O pad 206.

I/O component 204 includes a signal path between a receiver 216 and an I/O pad 206 (including a node 211, which can be alternatively referred to as an “intermediate node”). For example, this signal path includes an electrostatic discharge (ESD) component 220-1 comprising resistor 222 and diodes 226-1 and 226-2, the node 211, and inductors 212-3 and 212-1 of a Y-coil component 210. Inductors 212-3 and 212-1 can be configured to reduce capacitive reactance on the signal path (e.g., the path between the pad 206 and the receiver 216) such that signals sent on the signal path can meet particular bandwidth metrics for the I/O component 204.

I/O component 204 further includes signal path between a transmitter 214 and the I/O pad 206. For example, this signal path includes termination resistor 224, the node 211, and inductors 212-2 and 212-1 of the Y-coil component 210. Inductors 212-2 and 212-1 on signal path (e.g., the path between the pad 206 and the transmitter 214) can be configured to reduce capacitive reactance on the signal path such that signals sent on the signal path can meet particular bandwidth metrics for the I/O component 204.

A Y-coil circuit 210 can be connected to the I/O pad 206 to differentiate capacitive reactance from the I/O pad 206 and the signal drivers 214, 216 and to strengthen signal integrity. Y-coil circuit 210 can include inductors 212-2, 212-3, and 212-1. Each of the inductors 212-2, 212-3, and 212-1 are coupled to a node 211 (alternatively referred to as “center tap”). For example, the inductor 212-1 has its first terminal coupled to the I/O pad 206 and its second terminal coupled to the node 211; the inductor 212-2 has its first terminal coupled to the termination resistor 224 and its second terminal coupled to the node 211; and the inductor 212-3 has its first terminal coupled to an electrostatic discharge (ESD) component 220-1 and its second terminal coupled to the node 211.

The I/O component 204 further includes an ESD component 220-2 and a tunable capacitance component 213 respectively coupled to the Y-coil circuit 210 in parallel. For example, the ESD component 220-2 and the tunable capacitance component 213 are respectively coupled to a node 215 (that is further coupled to the node 211) in parallel. The ESD component 220-2 includes diodes 226-3 and 226-4 coupled to the node 215, and the capacitive reactance of ESD component 220-2 can be reduced by the Y-coil circuit 210.

The tunable capacitance component 213 includes a tunable capacitor network, comprising multiple capacitors 232-1, …, 232-N connected in parallel (e.g., to the node 215). Each capacitor is paired with a switch (e.g., switches 234-1, …, 234-N), which can be selectively enabled or disabled (e.g., by the controller 102 shown in FIG. 1) to achieve various combinations of capacitance values.

For example, the capacitor 232-1 is coupled with the switch 234-1; the capacitor 232-2 is coupled with the switch 234-2; and the capacitor 232-N is coupled with the switch 234-N. This configuration allows the capacitance of the tunable capacitance component 213 to be dynamically “tuned” as needed. Although the embodiments are not limited to the following, a switch can include an electronic switch, such as a bipolar junction transistor (BJT), junction field-effect transistor (JFET), insulated gate bipolar transistor (IGBT), or PIN diode; a microelectromechanical systems (MEMS) switch; a mechanical switch; or a solid-state switch, such as a Gallium Nitride (GaN) switch or CMOS switch, etc.

As used herein, “disabling” capacitors (e.g., capacitors 232) refers to “disabling” switches 234, which further refers to placing the switches 234 in an open position. Further, as used herein, “enabling” capacitors (e.g., capacitors 232) refers to “enabling” switches 234, which further refers to placing the switches 234 in a closed position. Those switches 234 that are in an “open” position disconnect respective signal lines (e.g., signal lines on which the switches are located), while those switches that are in a “closed” position connect respective signal lines.

As mentioned above, the capacitance component 213 can be dynamically tunable based on various types of demands including, but not limited to, ensuring signal stability and integrity, mitigating signal distortion, reducing undesired high-frequency signal peaking or attenuation; thereby, improving overall signal quantity, optimizing the bandwidth (e.g., of the system 100 shown in FIG. 1) over which data is transmitted (e.g., without excessive jitter, distortion, or attenuation), etc. For example, the capacitance component 213 can be dynamically tunable to enable relatively more capacitors 232 (or disable relatively less capacitors 232) when the system 100 is (e.g., is determined to be) associated for shorter transmission channels or configurations with fewer memory ranks, enabling more capacitors to compensate for reduced parasitic, ensuring signal stability and integrity. In another example, the capacitance component 213 can be dynamically tunable to enable relatively less capacitors 232 (or disable relatively more capacitors 232) when the system 100 is (e.g., determined to be) associated for longer transmission channels or configurations with higher memory ranks, reducing capacitance minimizes capacitive loading, enabling higher operational speeds and improved efficiency.

The total capacitance at node 215 is determined by the combined contributions of the capacitance component 213 and the capacitance of the ESD 220-2 (e.g., fixed and inherent to the diodes 226-3 and 226-4). This can result in higher total capacitive loading at the node, potentially leading to lower bandwidth and increased attenuation as the circuit’s capacitive reactance increases. For example, when more capacitors 232 in the capacitance component 213 are enabled, the total capacitance at node 215 increases, which further affects (e.g., increases) the total capacitance at node 211. Conversely, when fewer capacitors 232 in the capacitance component 213 are enabled (or all are disabled), the total capacitance at node 215 decreases, which further affects (e.g., decreases) the total capacitance at node 211. This reduction in capacitive loading at node 215 as well as at node 211 can lead to higher bandwidth as the capacitive reactance decreases, enabling the circuit to handle higher frequencies more efficiently. This adjustment allows the circuit to dynamically optimize bandwidth and signal integrity across both nodes.

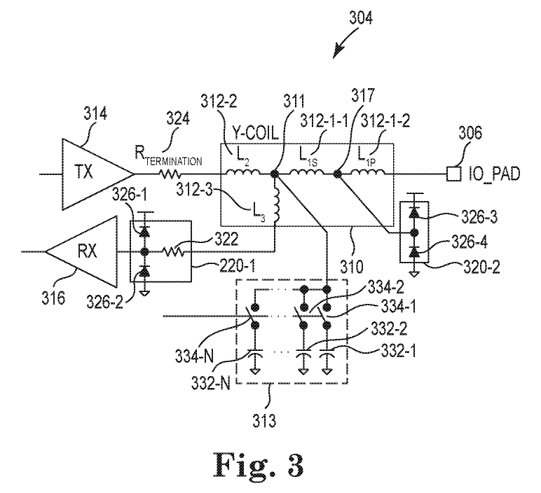

FIG. 3 is a block diagram illustrating another example I/O component 304 including a tunable capacitance component 313 in accordance with a number of embodiments of the present disclosure. The I/O component 304 is analogous to the I/O component 104, 204 respectively shown in FIGS. 1 and 2. Similarly, the tunable capacitance component 313 is analogous to the tunable capacitance component 113, 213 respectively shown in FIGS. 1 and 2. For example, the capacitor 332-1 is coupled with the switch 334-1; the capacitor 332-2 is coupled with the switch 334-2; and the capacitor 332-N is coupled with the switch 334-N. This configuration allows the capacitance of the tunable capacitance component 313 to be dynamically “tuned” as needed.

As mentioned above, the capacitance component 313 can be dynamically tunable based on various types of demands including, but not limited to, ensuring signal stability and integrity, mitigating signal distortion, reducing undesired high-frequency signal peaking or attenuation; thereby, improving overall signal quantity, optimizing the bandwidth (e.g., of the system 100 shown in FIG. 1) over which data is transmitted (e.g., without excessive jitter, distortion, or attenuation), etc. For example, the capacitance component 313 can be dynamically tunable to enable relatively more capacitors 332 (or disable relatively less capacitors 332) when the system 100 is (e.g., is determined to be) associated for shorter transmission channels or configurations with fewer memory ranks, enabling more capacitors to compensate for reduced parasitic, ensuring signal stability and integrity. In another example, the capacitance component 313 can be dynamically tunable to enable relatively less capacitors 332 (or disable relatively more capacitors 332) when the system 100 is (e.g., determined to be) associated for longer transmission channels or configurations with higher memory ranks, reducing capacitance minimizes capacitive loading, enabling higher operational speeds and improved efficiency.

FIG. 3 is generally analogous to FIG. 2 except that the Y-coil 310 includes an additional inductor 312-1-2 coupled between the inductor 312-1-1 and the I/O pad 306. This configuration of the Y-coil 310 allows an ESD component 320-2 (analogous to the ESD component 220-2 shown in FIG. 2) to be coupled to a node 317 located between the inductor 312-1-1 and the inductor 312-1-2, as compared to the configuration shown in FIG. 2, in which the ESD component 220-2 and the tunable capacitance component 213 are coupled to the same node (e.g., the node 211) in parallel.

More particularly, the total capacitance at node 311 is determined by the contributions of the capacitance component 313. This can result in higher total capacitive loading at the node, potentially leading to lower bandwidth and increased attenuation as the circuit’s capacitive reactance increases. For example, when more capacitors 332 in the capacitance component 313 are enabled, the total capacitance at node 311 increases. Conversely, when fewer capacitors 332 in the capacitance component 313 are enabled (or all are disabled), the total capacitance at node 311 decreases. This reduction in capacitive loading at node 311 can lead to higher bandwidth as the capacitive reactance decreases, enabling the circuit to handle higher frequencies more efficiently. This adjustment allows the circuit to dynamically optimize bandwidth and signal integrity across both nodes.

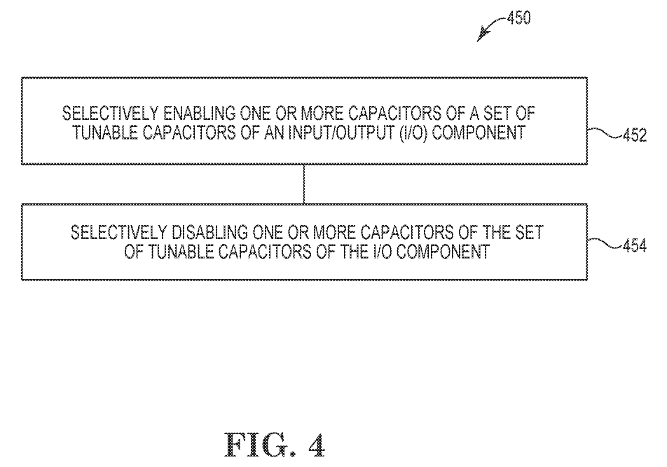

FIG. 4 is a flow diagram 450 of a method for operating a tunable capacitance component in accordance with a number of embodiments of the present disclosure. The method as illustrated by the flow diagram 450 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method is performed by controller 102 (alternatively referred to as “control circuit”) illustrated in FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At 452, one or more capacitors of a set of tunable capacitors (e.g., capacitors 232-1, …, 232-N of the tunable capacitance component 213 and/or capacitors 232-1, …, 232-N of the tunable capacitance component 213 respectively shown in FIGS. 2 and 3) of an input/output (I/O) component (e.g., an I/O 104, 204, 304 respectively shown in FIGS. 1-3) can be selectively enabled.

The set of tunable capacitors is coupled to a coil circuit (e.g., y-coil 210, 310 respectively shown in FIGS. 2 and 3) comprising one or more inductors (e.g., inductors 212, 312 respectively shown in FIGS. 2 and 3) and coupled between one or more signal drivers (e.g., signals drivers 214, 216 and/or signal drivers 314, 316 respectively shown in FIGS. 2 and 3) and an I/O pad (e.g., an I/O pad 206, 306 respectively shown in FIGS. 2 and 3). At 454, one or more capacitors of the set of tunable capacitors of the I/O component can be selectively disabled.

In some embodiments, each capacitor of the set of capacitors is coupled to a respective switch of a set of switches (e.g., switches 234, 334 respectively shown in FIGS. 2 and 3) that can be placed in an open or closed position during operation of the I/O component. For example, selectively enabling the one or more capacitors of the set of tunable capacitors of the I/O component further comprises selectively placing respective one or more switches of the set of switches in a closed position. Further, for example, selectively disabling the one or more capacitors of the set of tunable capacitors of the I/O component further comprises selectively placing respective one or more switches of the set of switches in an open position.

Although specific embodiments have been illustrated and described herein, those of ordinary skill in the art will appreciate that an arrangement calculated to achieve the same results can be substituted for the specific embodiments shown. This disclosure is intended to cover adaptations or variations of one or more embodiments of the present disclosure. It is to be understood that the above description has been made in an illustrative fashion, and not a restrictive one. Combination of the above embodiments, and other embodiments not specifically described herein will be apparent to those of skill in the art upon reviewing the above description. The scope of the one or more embodiments of the present disclosure includes other applications in which the above structures and processes are used. Therefore, the scope of one or more embodiments of the present disclosure should be determined with reference to the appended claims, along with the full range of equivalents to which such claims are entitled.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. An apparatus, comprising:
an input/output (I/O) pad; and
a first signal driver coupled to the I/O pad with an intermediate node located between the first signal driver and the I/O pad;
a second signal driver coupled to the I/O pad with the intermediate node located between the second signal driver and the I/O pad;
a tunable capacitance component coupled to the intermediate node, the tunable capacitance component comprising a set of capacitors that can be selectively enabled or disabled to adjust capacitive loading of the apparatus.

2. The apparatus of claim 1, wherein each capacitor of the set of capacitors is further coupled to a respective switch.

3. The apparatus of claim 1, wherein the set of capacitors are coupled to the intermediate node in parallel.

4. The apparatus of claim 1, further comprising a coil circuit including a number of inductors surrounding the intermediate node such that:
a first inductor of the number of inductors having a respective first terminal coupled to the I/O pad and a respective second terminal coupled to the intermediate node;
a second inductor of the number of inductors having a respective first terminal coupled to first signal driver and a respective second terminal coupled to the intermediate node; and
a third inductor of the number of inductors having a respective first terminal coupled to the second signal driver and a respective second terminal coupled to the intermediate node.

5. The apparatus of claim 4, wherein the coil circuit further comprises a fourth inductor of the number of inductors coupled between the first inductor and the intermediate node.

6. The apparatus of claim 5, further comprising a first electrostatic discharge (ESD) component coupled to a node located between the first and fourth inductors.

7. The apparatus of claim 4, further comprising a second electrostatic discharge (ESD) component coupled between the second signal driver and the third inductor.

8. The apparatus of claim 4, further comprising a termination resistor coupled between the first signal driver and the second inductor.

9. The apparatus of claim 4, wherein:
the first signal driver corresponds to a transmitter; and
the second signal driver corresponds to a receiver.

10. The apparatus of claim 1, wherein the intermediate node corresponds to a first node and the apparatus further comprises a second node with a signal path coupled between the first node and the second node.

11. The apparatus of claim 10, further comprising a first electrostatic discharge (ESD) component coupled to the second node in parallel with the tunable capacitance component.

12. The apparatus of claim 10, wherein the set of capacitors of the tunable capacitance component are coupled to the second node in parallel.

13. A system, comprising:
a control circuit; and
an input/output (I/O) component coupled to the control circuit, the I/O component further comprising:
an I/O pad;
a first signal driver coupled to the I/O pad;
a second signal driver coupled to the I/O pad;
a coil circuit comprising one or more inductors and coupled between the first signal driver and the I/O pad or between the second signal driver and the I/O pad; and
a tunable capacitance component coupled to the coil circuit, the tunable capacitance component comprising a set of capacitors; and
wherein the control circuit is configured to selectively enable or disable each capacitor of the set of capacitors to adjust capacitive loading of the transceiver.

14. The system of claim 13, wherein the control circuit is configured to selectively enable more capacitors of the set of capacitors to strengthen signal integrity of signals transmitted by the transceiver.

15. The system of claim 13, wherein the control circuit is configured to selectively disable more capacitors of the set of capacitors to increase bandwidth of the transceiver.

16. The system of claim 13, wherein the I/O component corresponds to a bi-directional I/O component.

17. A method, comprising:
selectively enabling one or more capacitors of a set of tunable capacitors of an input/output (I/O) component, wherein the set of tunable capacitors is coupled to a coil circuit comprising one or more inductors and coupled between one or more signal drivers and an I/O pad; and
selectively disabling one or more capacitors of the set of tunable capacitors of the I/O component.

18. The method of claim 17, wherein each capacitor of the set of capacitors is coupled to a respective switch of a set of switches that can be placed in an open or closed position during operation of the I/O component.

19. The method of claim 18, wherein selectively enabling the one or more capacitors of the set of tunable capacitors of the I/O component further comprises selectively placing respective one or more switches of the set of switches in a closed position.

20. The method of claim 18, wherein selectively disabling the one or more capacitors of the set of tunable capacitors of the I/O component further comprises selectively placing respective one or more switches of the set of switches in an open position.
